(19) United States
(12) Patent Application Publication
(10) Pub. No.: US 2025/0150019 A1
(43) Pub. Date: May 8, 2025

(54) SOLAR CELL SYSTEM AND METHOD FOR MOUNTING ON ROOF

(71) Applicant: Tore Hassel, Sandnes (NO)

(72) Inventor: Tore Hassel, Sandnes (NO)

(21) Appl. No.: 18/836,972

(22) PCT Filed: Feb. 13, 2023
(86) PCT No.: PCT/NO2023/050034

§ 371 Date: Aug. 8, 2024

(30) Foreign Application Priority Data
Feb. 11, 2022 (NO) 20220196

(51) Int. Cl. H02S 20/23; H02S 30/10

(52) U.S. Cl. CPC H02S 20/23; H02S 30/10

(57) ABSTRACT

A solar cell system is for use on a roof. The solar cell system has solar panels assembled in a longitudinal direction of the roof and in a width direction of the roof. The solar panels are adjoining each other, without overlap, in the longitudinal direction and are spaced apart in the width direction of the roof. A clamping profile is arranged in the longitudinal direction of the roof for clamping the solar panels down against the roof and for covering the gap between the solar panels in the width direction. The clamping profile is fastened directly to the roof by use of fastening means. A method for assembling a solar cell system on a roof is also described.

### CROSS-REFERENCE TO RELATED APPLICATIONS

This application is the U.S. national stage application of International Application No. PCT/NO2023/050034, filed Feb. 13, 2023, which international application was published on Aug. 17, 2023, as WO 2023/153938 in the English language. The International Application claims priority to Norwegian Patent Application No. 20220196, filed Feb. 11, 2022. The international application and Norwegian application are both incorporated herein by reference, in their entirety.

### FIELD

The invention concerns a solar cell system for roof. More specifically, the invention concerns a solar cell system for roof wherein a plurality of solar panels is placed in a matrix in the longitudinal direction and width direction of the roof, and wherein the solar panels are assembled adjoining each other in the longitudinal direction, without overlapping, and in the width direction of the roof with a small distance between them. The invention also concerns a method for assembling such a solar cell system on a roof.

### BACKGROUND

In many ways, we live in a critical time. The CO₂-level is alarmingly high. Fossil energy has given us efficiency and wealth, but it turns out that we are approaching nature's tolerance limit and that a transition to clean energy is inevitable. We see it in natural damages, change in weather systems, melting of glaciers, warmer oceans, etc.

The demand for energy will still be great in the future, and we get a logical, ethical, and moral responsibility for providing an energy production which causes as little damage as possible on nature, climate and wildlife. Thus, it rests upon us; engineers and inventors, to find methods and new technologies and to develop, test and promote new solutions for increased production of environmentally friendly energy.

Hydroelectric power is also clean energy, but it is at the expense of fishing lakes, rivers, and nature. Wind power on land has negative effects on bird life, and more nature is destroyed.

Solar energy integrated on/in buildings, so-called “building-integrated photovoltaics” (BIPV), is seen by many as the least intrusive alternative. Used together with other power production, BIPV can make a difference if it is scaled to a large volume. Solar energy produces clean and nature friendly energy, but there are still very few solar energy roofs which are installed as BIPV. As of today, solar panels are typically installed on top of an already existing roof.

If volume and large energy production on the roof of buildings, is wanted, BIPV might well be the best solution. This is because BIPV with effective solutions provides double benefit without doubling the price; both a tight roof and clean energy.

The reasons for lack of BIPV adoption, are complex, but can be summed up this way; too high costs, lack of standards, a mix of specialized fields with diffuse boundaries, and solar panels with no standardized dimensions. SINTEF in Norway has written a report on this: SINTEF: “Bruk av bygningsintegrerte solceller (BIPV) i Norge”. (Eng: “Use of building-integrated solar panels (BIPV) in Norway.”)

As of today, most solar panels are installed as external panels fastened on top of existing roof. This tends to be unsightly and expensive and represents a risk of leakage when fastenings are to be made in existing roof, which will often mean twice as much work on the roof.

BIPV has the potential to become more cost-effective and can also become very important in the green shift. Here, two functions are combined: tight roof and production of electrical energy. In a desired future, one can imagine all buildings being constructed with solar panels on the roof, preferably also on the walls.

To get there, good and efficient solutions must be developed. First with standardized, efficient, and durable solar panels. Then a high-quality assembly with quick and efficient installation, since the price to the end user will be crucial.

### SUMMARY

It is an object of the present invention to contribute to fully or partially solving the above-mentioned challenges; to provide cheaper solar energy on roof, so that ordinary homeowners can afford it. The goal is to install standardized solar roofs in large volumes.

Other suggested solutions for tight BIPV installation, are known, for example as disclosed in SE1951313A1.

The invention has for its object to remedy or to reduce at least one of the disadvantages of prior art, or at least to provide a useful alternative to the prior art. The object is achieved by the features set out in the description below and in the subsequent patent claims.

The invention is defined by the independent patent claims. The dependent claims define advantageous embodiments of the invention.

In a first aspect, the invention concerns a solar cell system on roof, wherein the solar cell system comprises a plurality of solar panels installed in a matrix in the longitudinal direction of the roof and in the width direction of the roof, where the solar panels are adjoining each other, without overlap, in the longitudinal direction and where the solar panels are spaced apart in the width direction of the roof, where a clamping profile is arranged in the longitudinal direction of the roof for clamping the solar panels down against the roof and for covering the gap between the solar panels in the width direction of the roof, where the clamping profile is fastened directly to the roof by use of fastening means.

By “longitudinal direction” is herein meant a direction from the ridge of the roof and down towards a lower edge, for a pitched roof. By “width direction” is meant the direction perpendicular to the longitudinal direction, between the outer edges of the roof. Also “flat” roofs will normally be slightly pitched, typically 6° or a little less.

In an embodiment where the roof comprises a plurality of rafters arranged in the roof's longitudinal direction and spaced-apart in the roof's width direction, the width of the solar panels can be adapted to the distance between the rafters. The distance will typically be about 60 cm, even though the invention will not be limited to this. Typically, the solar panels may be of a rectangular shape and have a size of approx. 60 cm×120 cm. By “approx. 60 cm” is meant that if the centre distance between the rafters, in the width direction of the roof, is 60 cm, the solar panels have to be 60 cm wide minus the gap between the panels installed in the width direction. The solar panels are further advantageously “frameless”, i.e., the solar panels are designed with a substantially smooth surface without elevations and without a typical frame which is common for single solar panels.

It should be noted that by “rafters” is meant support elements, preferably wooden, arranged in the longitudinal direction of the roof. Such rafters, which follow the direction of the principal rafter.

In an advantageous embodiment, the clamping profiles can be fastened directly to the rafters of the roof. The fastening means will typically be screws, even though the invention is not limited thereto. This will provide a simple fastening of the clamping profiles to the roof, and the clamping profiles will in turn provide clamping force against the solar panels which are “floating” without any direct fastening to the roof, potentially with the exception of an indirect fastening of a lower panel by means of an anchor, as explained below.

In an embodiment, a lower solar panel in the longitudinal direction of the roof may be fastened to the roof by means of an anchor, i.e., each of the lower solar panels in the longitudinal direction of the roof is fastened directly to the roof and bears against a stopper/anchor which is fastened directly or indirectly to the roof. The remainder of the solar panels in the longitudinal direction of the roof then rest against the lower solar panel without being directly fastened to the roof. Even though the solar panels in the system have a certain weight and good friction against the roof, due to the clamping force of the clamping profiles and due to rubber sealings as explained below (if present), the solar panels will, over time, migrate a bit down towards the lower, anchored solar panel.

In an embodiment the anchor can be fastened to the lower end of the clamping profile. This means that the anchor is indirectly fastened to the roof through fastening to the clamping profile, which in turn, typically is fastened directly to the rafters of the roof by screw connections. The anchor may be formed as an end stopper/end lock, fastened to the lower, potentially open, end of the clamping profile, with a design such that it protrudes beyond the cross-section of the clamping profile, whereby one solar panel or two neighbouring panels come into contact with the anchor and rest against it. The anchor may be screwed into the end of the clamping profile, for example in a female connection, as explained below. The anchor may be a thick piece of metal which is laser cut or shaped in other ways, the metal being for instance aluminium, for example of a thickness of 4 mm. Thus, it is an advantage if the clamping profile is fastened with a plurality of spaced-apart screws in the longitudinal direction of the roof, and directly in the rafters of the roof in the longitudinal direction. For example, the clamping profile may be screwed to the rafters of the roof by a plurality of screws evenly distributed over the length of the clamping profile. If the clamping profile is divided into shorter lengths, for example of 120 cm, three, four or preferably five or more screws can be used over the length of the clamping profile. Together with the end stopper, this will give the lowermost solar panels a good attachment up along the roof and will still provide good attachment even if one or more rafters were to be damaged by moist or rot.

In an embodiment the solar cell system may comprise a power pack which pre-tensions the solar panels in the longitudinal direction of the roof from the top and in the direction towards a lower solar panel. On roofs having a pitch above a certain angle, gravitation will typically be sufficient to pack the solar panels tightly together over time in the longitudinal direction of the roof, typically with seals and/or rubber substance in between, either directly or via metal fittings. When the BIPV system is not only supposed to produce electricity but also take care of the functions necessary for a tight roof covering, it is important that there really are sufficient forces acting on the solar panels to provide a good clamping force/packing effect between them in order to avoid leakage towards the underroof. On roofs with smaller pitch, for example below 25°, below 20° or below 15° it could be useful to pre-tension the upper solar panel in the matrix downward in the longitudinal direction of the roof. This can be done by a power pack which exercises force downward from the upper solar panel.

In an embodiment the clamping profile may be divided into shorter lengths so that several clamping profiles are assembled in the longitudinal direction of the roof. To ensure correct/precise alignment of the clamping profiles, these can be designed with male/female connections. The clamping profile may advantageously be adapted to the solar panels' length, for example 120 cm. This will simplify both transport and installation.

In an embodiment, the abutment of the solar panels against the roof may consist of a seal strip made of an elastic material, for example rubber, and where the seal strip is designed with side channels extending in the entire longitudinal direction of the roof and arranged to divert water. This will be useful both in order to ensure gentle abutment against the underroof/rafters, and also for diverting water away from any leakage through the roof covering, i.e., the solar panels and the clamping profiles. Similarly, it will also be an advantage if the abutment of the clamping profiles against the solar panels are constituted of seals, typically one on either side, extending in the longitudinal direction of the roof, both in order to seal against water ingress under/on the side of the clamping profile and also to ensure a gentle abutment and even clamping force down against the solar panels.

In some embodiments the solar cell system according to the first aspect of the invention provides a new BIPV assembly which makes use of standardized elements, and which is adapted to Norwegian building standard. In Norway, one would typically use 60×120 cm solar panels, which fit directly onto standard buildings with a 60 cm distance between roof beams and rafters. In other markets, the assembly is adapted to the local/national building standards.

The solar cell system according to the invention will provide a durable and tight roof covering, at the same time as it is simple and relatively cheap to install.

In accordance with a second aspect, the invention concerns a method for assembling a solar cell system on roofs, wherein the method comprises the steps:
placing a matrix of solar panels in the roof's longitudinal direction and width direction without overlap;
placing the solar panels adjoining each other in the longitudinal direction of the roof;
placing a clamping profile in the longitudinal direction of the roof for closing the gap between the solar panels in the width direction of the roof; and
fastening the clamping profile directly to the roof by means of fastening means.

In an advantageous embodiment, the solar panels may be adapted to the width of the roof rafters and be placed directly on top of these. The clamping profile may then be fastened directly, for example by means of screws, to the rafters.

### BRIEF DESCRIPTION OF THE DRAWINGS

In the following, examples of preferred embodiments, which are illustrated in the accompanying drawings, are described, where:

FIG. 1 shows, seen in section and oblique view from below, a solar cell system on a roof;

FIG. 2 shows, seen in section from the side, a solar cell system on a roof with large pitch;

FIG. 3 shows, seen in section from the side, a solar cell system on a roof with small pitch;

FIG. 4 shows, seen in section obliquely from below, details of a solar cell system at an end portion of the roof;

FIGS. 5A, B show, seen from above and in perspective, respectively, clamping profiles as used in a solar cell system;

FIG. 6 shows, seen in section from the side, a transition between two solar panels in the longitudinal direction of the roof;

FIG. 7 shows, seen in section from the side, a solar cell system on roof;

FIG. 8 shows, seen in section from the side, an alternative solar cell system on roof;

FIG. 9 shows, seen in section from the side, a further alternative solar cell system on roof;

FIG. 10 shows, schematically, seen from the side, end portions of a solar cell string;

FIG. 11 shows, schematically, seen from the side, a connection between two solar panels;

FIGS. 12A, B show, schematically, seen from the side, a solar panel having connection boxes at the top and a click panel at the bottom, respectively; and

FIGS. 13A, B show, schematically, seen from above, stacking of various types of solar panels on pallet.

### DETAILED DESCRIPTION OF THE DRAWINGS

All position indications refer to the position shown in the Figures.

In the Figures, the same or corresponding elements are indicated with the same reference number. For the sake of clarity, some elements may be without reference numbers in some of the Figures.

A skilled person in the field, will understand that the Figures are principle drawings, only. The relative proportions between individual elements may also be distorted.

The invention provides a new solar cell system and a new method for assembling of BIPV. The method is performed like this: On top of roof beams 100, planks, plates and membrane 110 are placed. Only membrane, may also occur. Most often this underroof 110 will already be built and ready when the solar panels are to be installed. Thereafter, rafters 150 are laid up along the roof, preferably placed directly on top of the roof beams 100 for best possible fastening with fasteners 120 down into the beams. The fasteners may typically be screws. On top of the rafters 150, seal strips 160 formed with side channels, are placed.

The seal strip 160 works both as support for solar panels 170 against the roof and as channels for any minor water leakages through the upper layer of solar panels 170 and clamping profiles 200. The solar panels 170, which preferably are adapted to the centre distance between the roof beams, are placed on top of the seal strip 160 which in turn is placed on top of the rafters 150 and are clamped to the roof by the clamping profile 200 via two seals 205. The seals 205 can be fastened to the clamping profile 200, or the seals can be separate components which are arranged between the clamping profile and the solar panel. The clamping profile 200 is clamped down onto the solar panels 170 by means of the fastening elements/screws 120 which are fastened directly in the rafters 150, so that the side edges on the clamping profiles become watertight by means of pressure on the seals 205. Between the solar panels 170 downwardly in the longitudinal direction of the roof, fittings 250 are used, preferably also with seals 255. One can also use seals 255 without fittings 250. This way, water is diverted past the joints between the solar panels 170 in the longitudinal direction and further downwardly on the roof. The solar cell system is divided into a simple and logical construction kit. After placement of rafters 150 and seal strip 160, a solar panel 170 is placed thereon and clamped firmly with the clamping profile 200. Thereafter, the fitting 250 and/or the seal 255 only, is arranged thereon, before proceeding to the next solar panel 170 until the entire roof is installed.

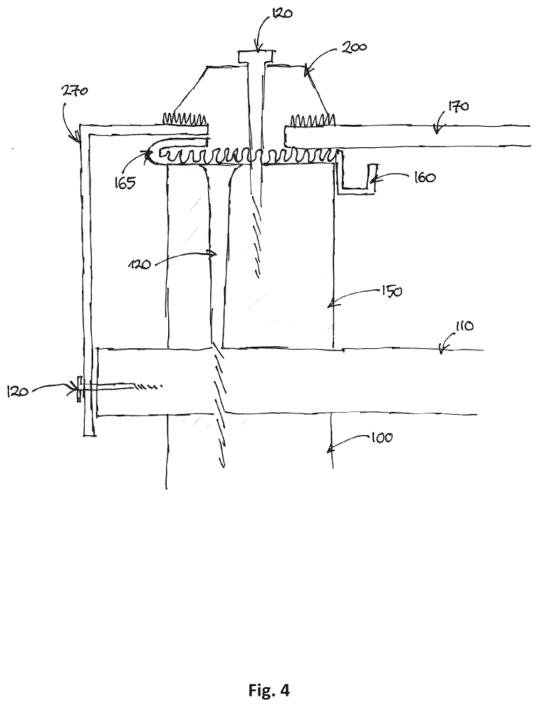

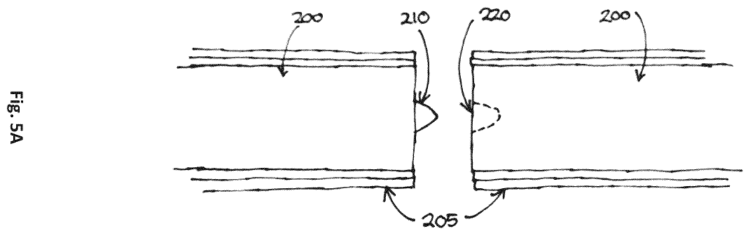

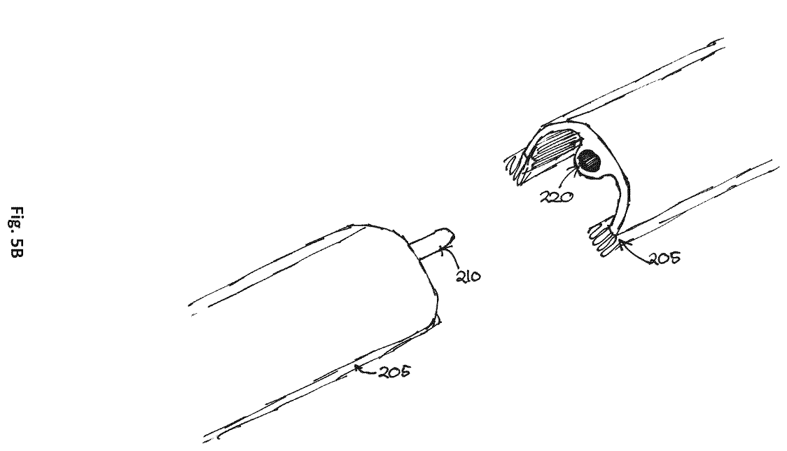

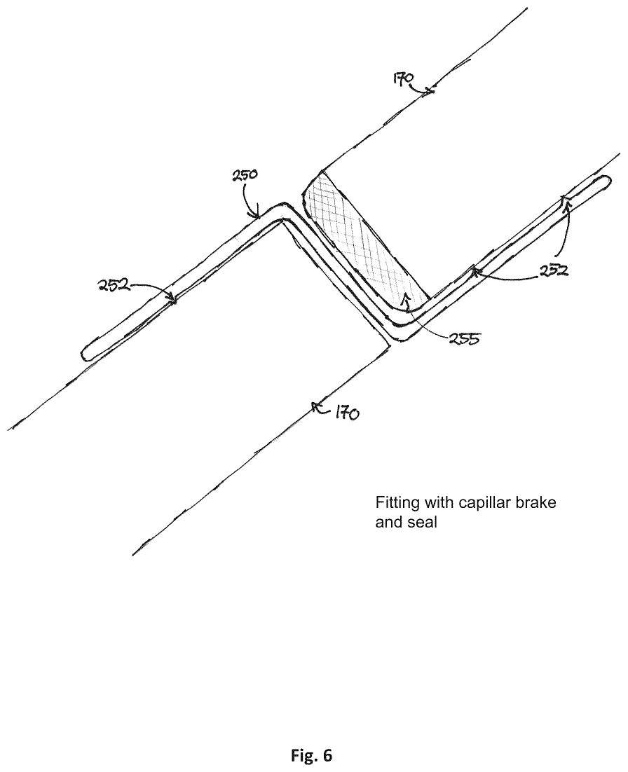

Preferably, side fittings fit directly into the clamping profiles 200, as shown in FIG. 4. For fittings and seals on the top and bottom of the solar roof, normal, good building practice for roofs is used. All long elements are preferably split up, as indicated in FIGS. 5A and B. Experience from buildings have shown that long profiles are disadvantageous. They can be dangerous to handle on a roof, especially in strong winds, and they are more expensive to distribute. A doubling of transport costs has been observed when sending clamping profiles 200 of full length by car. Further, uncut clamping profiles 200 will take up more space in a construction area, and they can easily be damaged. The profiles are most often varnished or anodized for appearance, and they are expensive to repair or refinish.

Therefore, it is an object of the system and the method to provide a clamping profile 200 which is simpler and safer, both for construction sites and in distribution. This also leads to the assembling being more efficient and more economic for the end customer.

The clamping profiles 200 are all cut into lengths suitable for standard load carriers for transport, as for instance European pallets.

A disadvantage of short clamping profiles 200 is that they can be difficult to install in a straight line along the longitudinal direction of the roof, and that the clamping force they provide, may vary. It can easily happen that short elements do not align perfectly up along the roof. Even small deviations can be easily visible since such long lines can seem “wobbly” if you look along the profiles from a distance. Another issue is that sealing against the underroof can be of various degree if the clamping profile 200 is not placed exactly onto the middle of the gap between two solar panels 170 in the width direction of the roof.

It is also an advantage if the clamping force from the clamping profiles 200 down against the solar panels 170 is uniform and “correct”. When the clamping profiles are divided into shorter elements, there is a danger that the clamping force will vary between the elements. One profile can be screwed on tightly with a large clamping force, while another one can be less firmly screwed-on using a small clamping force. Centring and directing of the clamping profiles 200 can therefore be very advantageous in some embodiments. In the embodiment shown on FIGS. 5A and 5B, the clamping profiles 200 are provided with a bolt, a spike or other guide 210 in one end and which fits complementary with a groove/recess 220 on another clamping profile 200, as a male/female-connection. This way, the clamping profiles 200 are forced into right position and direction, and correct alignment both in the longitudinal and width directions is achieved; straight line seen from the eaves and up towards the ridge. The alignment also accommodates equal clamping force down against the solar panels 170, since both directions are controlled by the accurate centring built-in into the profiles.

In some embodiments an extra groove can be added to the clamping profile 200, which can provide easy installation of additional equipment, such as snow guards and roof ladders. The same groove can also be used for separate top covers that are clicked onto the clamping profile if the customer wants covers of a different colour. An assembling system which allows for easy logistics, is very important for BIPV adoption and scale-up.

To allow and simplify the work and foot traffic on the solar panels 170, double-tempered glass panels, so-called “glass-glass panels”, without a frame and laminated together, are preferably used. In addition to extreme strength, laminated glass also provides a good and durable protection against moisture of the active solar cells which are placed between the glass plates. Most often, solar panels are made with a plastic film under/behind the active solar cells. It is known that this film can let moisture through after some years, particularly if the solar panels are exposed to repeated freezing and thawing, or if they are installed in humid climates. Moisture which gets in onto the active solar cells will, over time, damage these and reduce the effect on the panels, and eventually the production of electrical power will stop.

Double and laminated tempered glass constitute very robust and durable building elements. In the literature, a degradation time for glass of up to 500,000 years is indicated.

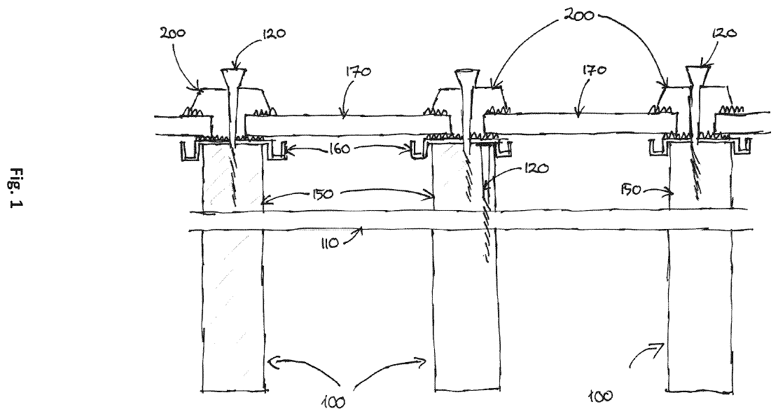

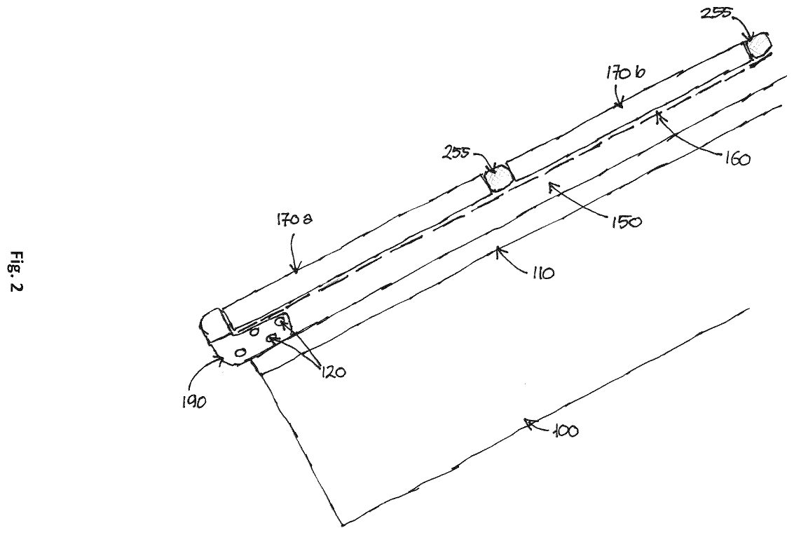

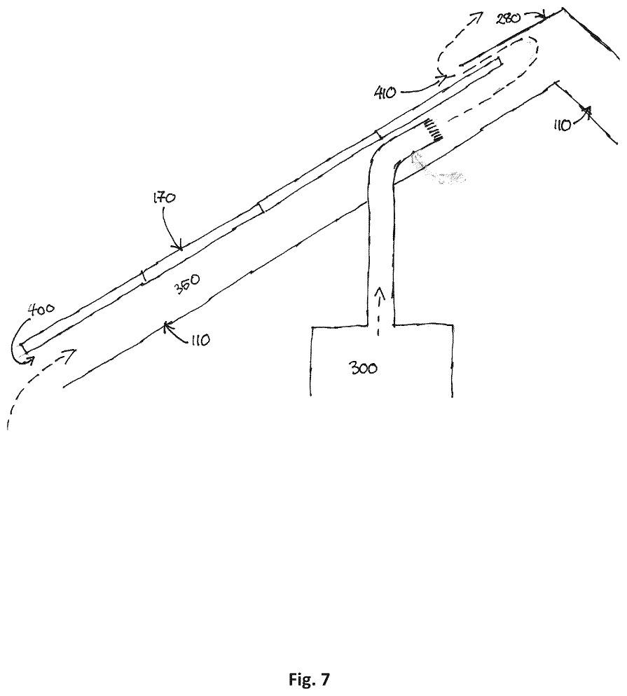

According to the invention, all the solar panels are installed “in-line”, i.e., without overlap. The solar panels 170 are installed adjoining each other with a gasket/seal and/or fittings between them in the longitudinal direction of the roof, while the solar panels 170 are placed at a small distance between them in the width direction of the roof. The distance in the width direction will typically be less than the width of a rafter 150, which generally is in the size range of 30-40 mm, but which is of course not limited to this. The distance between the solar panels 170 in the width direction of the roof may be in the order of size of ¼ to ¾, for example around half, of the width of the rafter, as indicated in FIG. 1. The in-line placement in the longitudinal direction is also shown in FIG. 7. This gives the solar panels 170 a flat and optimal contact surface, which is very advantageous for maximum mechanical strength. Frameless solar panels with double tempered glass 170 have been tested in connection with the present invention and have shown a load capacity of about 800 kg/m². Standard solar panels are generally tested to 400-600 kg/m². This extra strength makes it possible to walk and work on this kind of solar panels 170 when they are installed according to the present method. Being able to walk on them, means that assembling, maintenance and any replacement of panels will be much easier. This is useful for good and profitable operation.

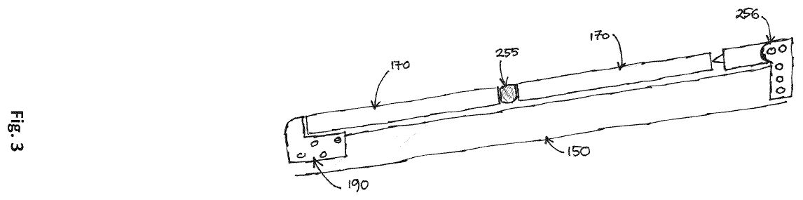

Reference is now made to FIG. 2. In order to keep the sealing over time, the solar cell system according to the invention uses a new and self-tightening technique. On a normal, pitched roof, it works like this; the lowermost solar panel 170 in the row 177 is anchored to the building by means of anchors 190. The anchor 190 may be directly or indirectly fastened to the building. The anchor 190 may be formed in many different ways. In one embodiment, it can be fastened to the lowermost end of the clamping profile 200, so that the lowermost solar panel 170 gets into abutment with the anchor 190 and rests against the anchor due to gravity. The other solar panels 170 in the row are assembled only with clamping between the seal strip 160 and the clamping profile 200. This way the solar panels are allowed to “migrate” downwards due to gravity, temperature changes, weather and wind. Tests have shown that one can assume around 0.5 mm migration per solar panel 170 per year in the beginning, but the “migration” will decrease as time passes by. Clamping on the gaskets/seals will endure for a long time and will contribute to essentially permanent operation without any leakage.

Uppermost/at the ridge of the sunroof, fittings 280 are installed with an overlap with the uppermost solar panel 170, as shown in FIG. 7. The ridge fitting is installed with sufficient overlap so that migration downwards over time will not cause leakage at the top.

Reference is now made to FIG. 3. Also on a flat or slightly pitched roof, the lowermost panel 170 in the row 177 is anchored to the building by means of the anchor 190, but the low pitch of the roof means that in some cases gravity will not provide enough force to maintain the necessary clamping on the seals over time. In such cases, an extra power pack 256 may be provided to give necessary clamping on said seals. The power pack is installed so that it exerts force downward on the upper solar panels 170 of the row 177. This way, the power pack will keep clamping on the seals, and consequently substantially complete sealing is maintained over a long period of time.

Again, reference is made to FIG. 1. Any minor leakages in the connections between the solar panels 170 downwardly on the roof, are handled by means of the seal strip 160 which is formed with longitudinal channel profiles on both sides. The seal strip provides three different functions: first, to form an optimal support for the solar panels 170 against the rafters 150, so that the solar panels 170 are placed with an even abutment against the rafter 150 to withstand maximum load. The second function is to divert water down from the roof and to the outside of the building. Last, also the seal strip 160 may be used for installing side fittings 270, as shown in FIG. 4. The side fittings 270 are usually made of aluminium and are quite thin compared to the solar panels 170, typically 1 mm thick compared to the 5-10 mm of the solar panels 170, as an example. In order to achieve good clamping and the right balance on the clamping profile 200, the channel profile is used for the seal strip 160 on one side of the extra “lining” in order to compensate for the difference in thickness between the side fittings 270 and the solar panel 170. The channel on the side of the seal strip 160 is then folded and used as an intermediate layer 165 for installation of the side fitting 270. According to the present disclosure, the seal strip 160 runs over the total length of the solar panel assembly downwards from the uppermost solar panel 170 and all the way down past the walls of the building, for protecting the building against water and moisture damage.

Reference is now made to FIG. 7. The rafters 150 may be dimensioned so that a large, open channel/chimney 350 upwardly along the roof, having a relatively large opening both lowermost and uppermost of the roof or of the row 177 of solar panels 170. The channel 350 may be used both for ventilation of moisture and for cooling of the solar panels 170. Both functions are important for good and lasting operation of the solar energy roof. Good ventilation is useful for removing condensation as well as for cooling in order to give the solar panels optimal conditions for electricity production. It is known that solar panels produce less electricity if they get very hot.

Chimney caps can be hidden/ventilated in the channel 350, with a lot of advantages. Tests performed by the present applicant indicate that small rooms, like WC or smaller bathrooms 300, can be ventilated under the solar panels 170, which means in the space/channel 350 formed by the underroof 110, the rafters 150 and the solar panels 170. Here, one can ventilate without making holes or special chimney caps up through the solar roof. This has many advantages, such as easier installation of the solar roof, no need to cut plates for arranging around the chimney cap, no need to make seals around chimney caps, less shadow falling on the solar panels resulting in lower electricity production, and avoiding snow and accumulation of particles around protruding chimney caps.

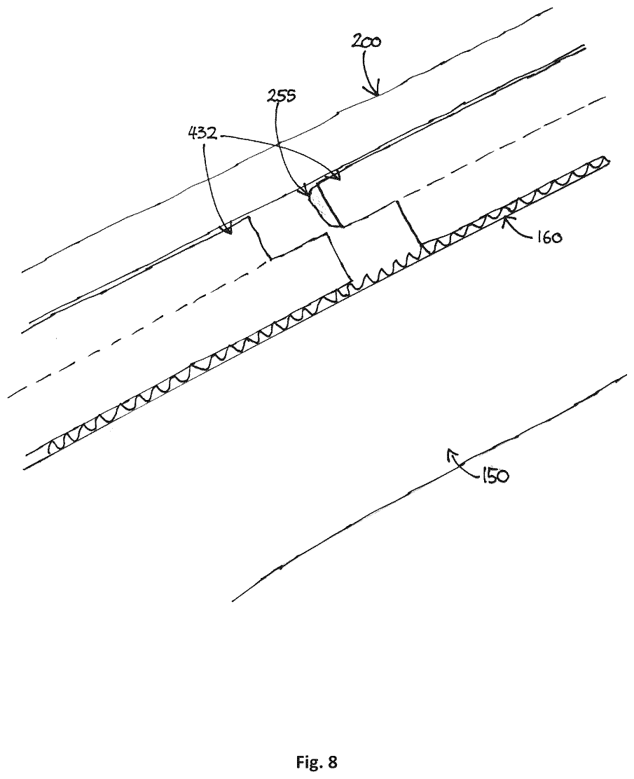

Reference is now made to FIG. 8 where an alternative embodiment, which is not part of the invention according to the set of claims, is shown. The assembly given by this alternative embodiment allows for a “fittings-free” assembly where the solar panels may form a completely smooth surface by means of a “click-panel assembly”. With the glass-glass panels the glasses are laminated somewhat displaced, so that a stair 432 is formed. In this stair 432 the seal 255 is arranged on one or more of the surfaces. Fitting-free solar panels only use seals, and no fitting, between the panels. Since the solar panels also in accordance with this embodiment, will “migrate” down towards the lowermost, anchored panel, the seals 255 will be kept under constant pressure/clamping the entire time, which provides essentially full sealing over a long period of time. This way, one can avoid using fittings between the solar panels down along the longitudinal direction of the roof, and the surface will be even smoother with regard to snow, dust and other objects. This is positive for optimal electricity production, since clean solar panels produce more electricity. This also gives a clean and aesthetically nice roof. Further, fitting-free solar panels will reduce the installation work for the BIPV roof resulting in a lower price for the customer. Everything which can reduce costs, is positive for an increased adoption of BIPV.

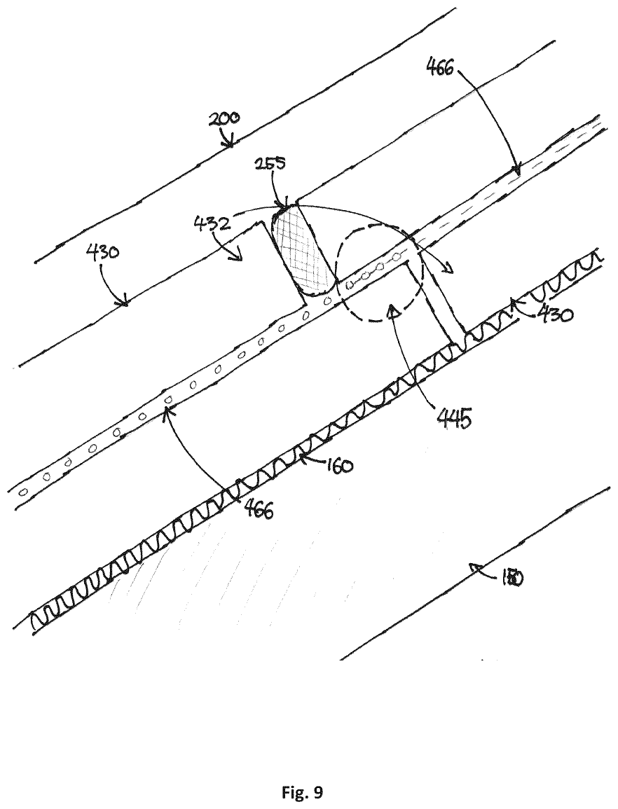

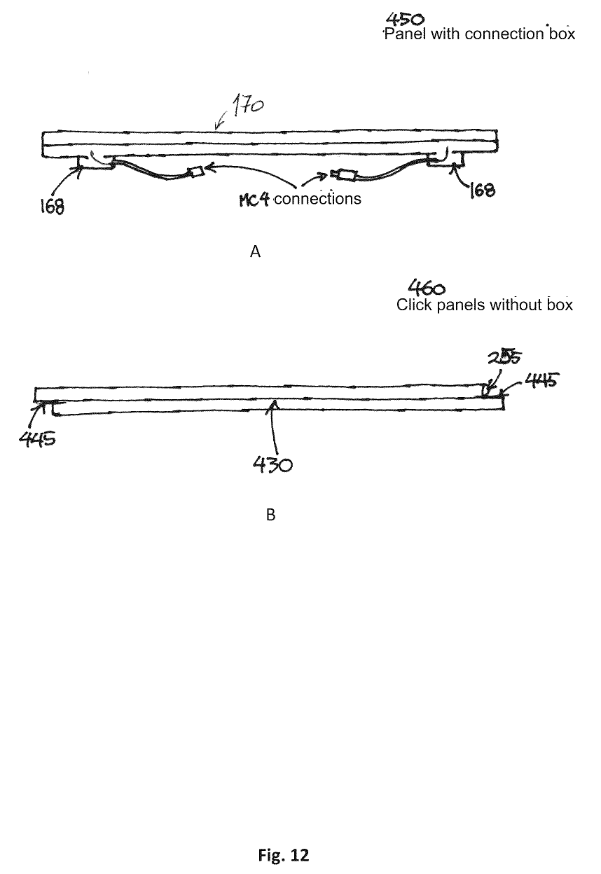

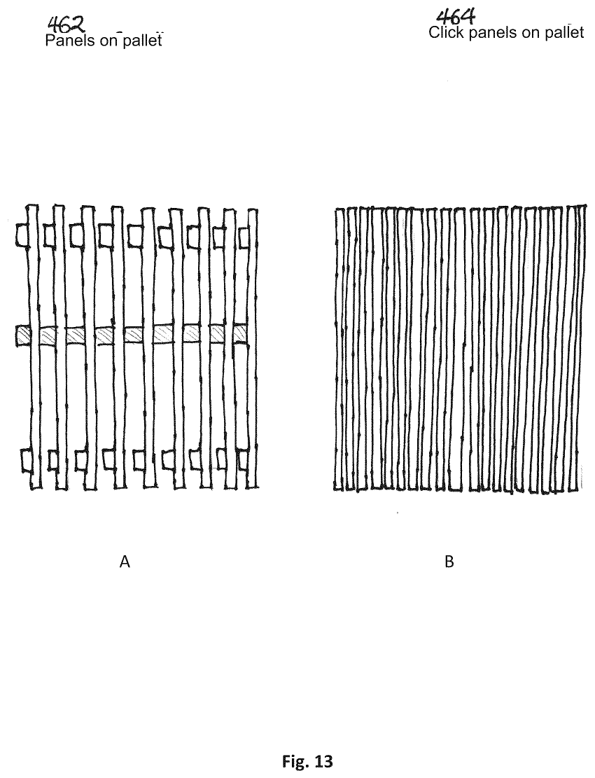

Reference is now made to FIG. 9, which also shows an embodiment which is not covered by the present set of claims. Cable free solar panels are installed without cables between the panels. The present applicant has tested two methods for cable free solar panels. The first, which can be used with glass-glass panels, is carried out as follows: while laminating the glasses, they are displaced relative to each other. This way, a stair 432 which is used both for mechanical connection, placement of seal 255 and electrical connection 445 of the solar panels, is formed. An advantage of the invention is to avoid the use of cables. Cables cause a lot of work, increase the costs, interrupt robotised handling and also increases costs for packing and transport. Another big advantage is to avoid connection boxes on the back of the panels 450, as shown in FIG. 12. Without connection boxes, production and transport of the solar panels will be further simplified, because the connection boxes with cables sticking out, are challenging when handling and packing 462, 464, both with robots and manually, as indicated in FIG. 13.

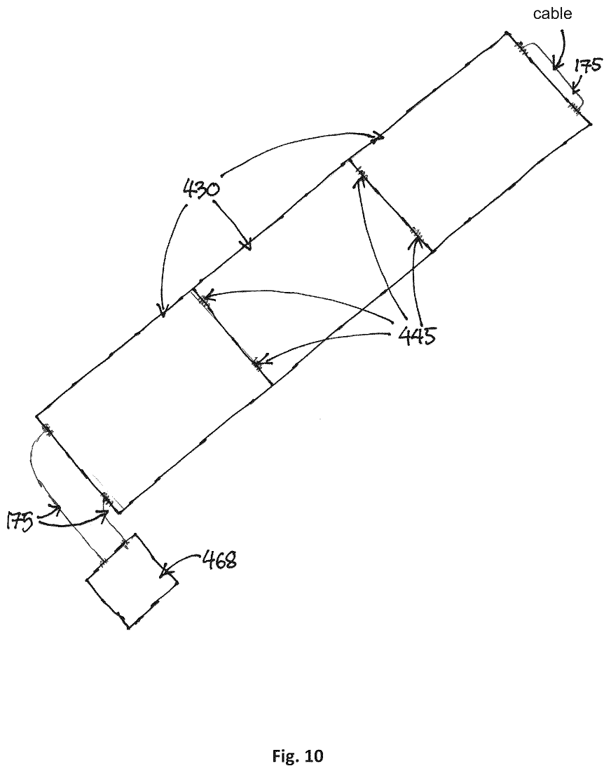

Also production of the click-panels become cheaper when one can avoid some steps which are typically present at production of “normal” solar panels: before tempering of the glass, the holes for the connection boxes have to be drilled. Thereafter, busbars 466 are to be guided through the holes before lamination, which involves manual work. Thereafter, the connection boxes are installed, glued on and soldered to busbars. With connection boxes and cables 450, handling and palletizing become bothersome. With the solar panels shown in FIG. 9, one avoid drilling of holes, since busbars are only sticking out at the ends. The connection boxes are no longer in use. This way, the panels become completely slick. No parts are sticking out, and robot handling and palletizing get much easier. Today a 40 ft container would ship 23 tonnes of solar panels. With tighter packing, as made possible by the solution shown in FIG. 9, a similar weight can be sent in a 20 ft container, as indicated in FIG. 13, where packing/stacking of solar panels 170, which are used in a solar cell system according to the invention, on a pallet, seen from above, is shown at the left side, while the corresponding packing of “click panels” having integrated electrical connections, is shown on the right. This means far less expensive transportation, a smaller CO₂ footprint, and reduced CO₂ emissions. The installation is thus completely cable-free with the exception of start/end 175 of a solar cell string 175, as indicated in FIG. 10.

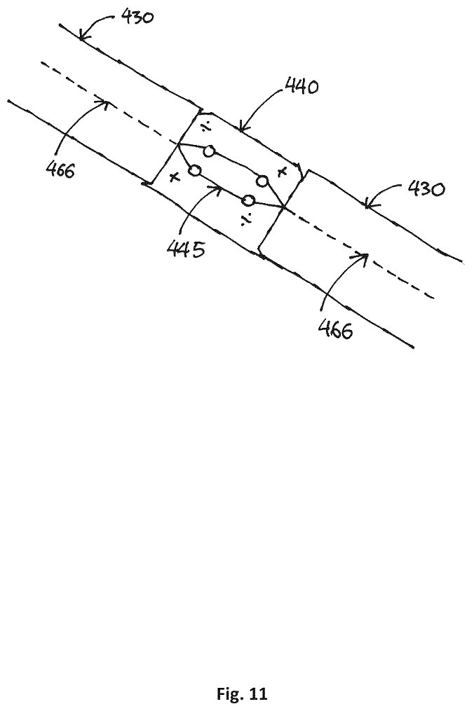

Reference is now made to the embodiment in FIG. 11. Here, an adapter 440 is used between the solar panels 430. The adapter 440 is placed between two solar panels 430 and connect these with each other via connections 445 against the protruding busbars 466 of the panels. The solar panels 430 with adapter are placed in the solar cell system, where said adapter 440 works both as sealing against water/moisture and as electrical connection between the panels. Together with the anchor 190 and the installation method described herein, the sealing will be maintained due to consistent clamping on the seals 255.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim.

Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

### CLAUSES

The following clauses describe details of the solar cell system which are not necessarily part of the present set of claims. The clauses may be used as basis for future claim amendments and/or divisional applications.
1. That the solar panels 170 are installed in the same plane (inline/in a line) and do not overlap other panels, this in order to maximize the strength against the support 160, 150 so that the solar panels get maximum mechanical strength, and that one can walk/work on top of the panels.
2. That the support of the solar panels against the building/roof is constituted by a sealing strip 160 made of an elastic material, such as rubber, and is provided with channels on the side, for handling of any smaller leakages, and run all the way down from the roof so that any water leakage will be diverted down and out past the walls of the house.
3. That the sealing strip from clause 2 is provided with channels for handling water leakage, these channels being designed so that they can also be used as lining for assembling of relatively thin fittings in the clamping profiles of the assembly.
4. That the clamping profiles 200 are split up for providing safer handling for the installers on the roof, but at the same time can be installed with great accuracy both concerning straightness up along the roof and with exactly the same clamping force down onto the solar panels. This by means of the guide provided by the invention, constituting a male part 210 and a female part 220 fitting each other accurately.
5. That in the lower part of the roof/solar panels at least one panel 170 is securely anchored to the building by means of an anchor 190. The other, above panels in the row are installed only by means of clamps between 160, 200 and are this way allowed to migrate downwardly towards the anchored panel under the influence of temperature changes, weather and wind, in order to retain sufficient clamp on the sealing elements 255 and/or on the fittings 250 over a very long time.
6. That for a low roof pitch, the same effect as for clause 5 is achieved by connecting a power pack on the row of solar panels which exerts the necessary force for maintaining sufficient clamping on the sealing elements 255 and/or on the fittings 250 over a very long time.
7. That said assembly provides an in-line assembly which gives a particularly even and smooth surface on the BIPV roof which snow and other objects find minimal attachment to. Which is important for the electricity production.
8. That the fittings used in the mentioned assembly are provided with capillary breaks 252 which stop water from creeping up along the fittings, so that moisture damage is avoided.
9. That said assembly allows ventilation in an easier manner due to the large ventilation channels of the assembly where ventilation can be hidden/placed within a channel 350 which is created between the underroof 110, rafter 150 and solar panel 170 and this way avoid chimney caps up through the solar roof.
10. That said assembly also allows use of click panels 430. By click panels are meant solar panels which can be installed as a continuous, substantially completely smooth glass surface without fittings, characterised in that the glasses are displaced relatively to each other, so that a stair 432 is formed between the upper and lower glass, wherein sealing 255 and mechanical connection are performed by means of said stair.
11. That the solar panels of clause 10 are also electrically connected to each other, without use of connection boxes, characterised in that electrical connections 445 are placed within, or in the area around said stair, in such a way that they are electrically isolated both from each other and externally.
12. Cable free solar panels, so-called click panels, which are without connection boxes 450 and which are characterised by the solar panels being electrically connected by means of an adapter 440 which is placed between the panels 430 and said adapter 440 is formed so that it both seals against water seeping in through the BIPV roof and at the same time connects the panels together electrically from protruding busbars 466 from solar panels via the terminals 445 which are built into said adapter.

1. A solar cell system on roof, wherein the solar cell system comprises a plurality of solar panels assembled in a longitudinal direction of the roof and in a width direction of the roof, where the solar panels are adjoining each other, without overlap, in the longitudinal direction of the roof, and where the solar panels are spaced apart in the width direction of the roof, where a clamping profile is arranged in the longitudinal direction of the roof for clamping the solar panels down against the roof and for covering a gap between the solar panels in the width direction, where the clamping profile is fastened directly to the roof via fastening means.

2. The solar cell system according to claim 1, wherein the roof comprises a plurality of rafters placed with a space between them, and wherein a width of the solar panels is adapted to the space between the rafters.

3. The solar cell system according to claim 2, wherein the clamping profiles is fastened directly to the rafters of the roof.

4. The solar cell system according to claim 1, wherein a lower solar panel in the longitudinal direction of the roof, is fastened to the roof via an anchor, and wherein a remainder of the solar panels in the longitudinal direction of the roof are resting against the lower solar panel without being directly fastened to the roof.

5. The solar cell system according to claim 4, wherein the anchor is fastened to a lower end of the clamping profile.

6. The solar cell system according to claim 5, wherein the clamping profile is fastened via a plurality of spaced-apart screws in the longitudinal direction of the roof and directly to rafters of the roof.

7. The solar cell system according to claim 1, wherein the solar cell system comprises a power pack which pre-tensions the solar panels in the longitudinal direction of the roof from a top of the roof and in a direction towards a lower solar panel in the longitudinal direction of the roof.

8. The solar cell system according to claim 1, wherein the clamping profile is divided into shorter lengths so that more clamping profiles are assembled in the longitudinal direction of the roof, and wherein the clamping profile is formed with male/female connections for ensuring correct alignment.

9. The solar cell system according to claim 8, wherein a length of the clamping profile is adapted to a length of the solar panels.

10. The solar cell system according to claim 1, wherein abutment of the solar panels against the roof is constituted by a seal strip in an elastic material, and wherein the seal strip is designed with side channels which extend in an entire extent of the roof in the longitudinal direction, and which are arranged to divert water.

11. A method for assembling a solar cell system on a roof, wherein the method comprises the steps of:
placing a matrix of solar panels in a longitudinal direction and a width direction of the roof without overlap;
placing the solar panels adjoining each other in the longitudinal direction of the roof;
placing a clamping profile in the longitudinal direction of the roof for closing a gap between the solar panels in the width direction of the roof; and
fastening the clamping profile directly to the roof via fastening means.

12. The method according to claim 11, the method comprising the steps of:
placing the matrix of the solar panels on rafters on the roof, and
fastening the clamping profile directly to the rafters of the roof with a fastening means.

13. The solar cell system according to claim 2, wherein a lower solar panel in the longitudinal direction of the roof, is fastened to the roof via an anchor, and wherein a remainder of the solar panels in the longitudinal direction of the roof are resting against the lower solar panel without being directly fastened to the roof.

14. The solar cell system according to claim 3, wherein a lower solar panel in the longitudinal direction of the roof, is fastened to the roof via an anchor, and wherein a remainder of the solar panels in the longitudinal direction of the roof are resting against the lower solar panel without being directly fastened to the roof.

15. The solar cell system according to claim 2, wherein the solar cell system comprises a power pack which pre-tensions the solar panels in the longitudinal direction of the roof from a top of the roof and in a direction towards a lower solar panel in the longitudinal direction of the roof.

16. The solar cell system according to claim 3, wherein the solar cell system comprises a power pack which pre-tensions the solar panels in the longitudinal direction of the roof from a top of the roof and in a direction towards a lower solar panel in the longitudinal direction of the roof.

17. The solar cell system according to claim 4, wherein the solar cell system comprises a power pack which pre-tensions the solar panels in the longitudinal direction of the roof from a top of the roof and in a direction towards a lower solar panel in the longitudinal direction of the roof.

18. The solar cell system according to claim 5, wherein the solar cell system comprises a power pack which pre-tensions the solar panels in the longitudinal direction of the roof from a top of the roof and in a direction towards a lower solar panel in the longitudinal direction of the roof.

19. The solar cell system according to claim 6, wherein the solar cell system comprises a power pack which pre-tensions the solar panels in the longitudinal direction of the roof from a top of the roof and in a direction towards a lower solar panel in the longitudinal direction of the roof.

20. The solar cell system according to claim 2, wherein the clamping profile is divided into shorter lengths so that more clamping profiles are assembled in the longitudinal direction of the roof, and wherein the clamping profile is formed with male/female connections for ensuring correct alignment.
